(19) United States
(12) Patent Application Publication
(10) Pub. No.: US 2010/0032949 A1
(43) Pub. Date: Feb. 11, 2010

(54) SYSTEM AND METHOD FOR ALTERING DRAG AND LIFT FORCES ON A WIND CAPTURING STRUCTURE

(75) Inventors: Craig Varrichio, Round Rock, TX (US); Mark Landry, Austin, TX (US); Anthony Varrichio, Plano, TX (US)

Correspondence Address: HULSEY IP INTELLECTUAL PROPERTY LAWYERS, P.C., 919 Congress Avenue, Suite 919, AUSTIN, TX, 78701, US

(73) Assignee: CMNA Power, Austin, TX (US)

(21) Appl. No.: 12/466,986

(22) Filed: May 15, 2009

Related U.S. Application Data
(63) Continuation-in-part of application No. 12/188,867, filed on Aug. 8, 2008.

(51) Int. Cl. F03D 7/00; B64C 31/06; F03D 9/00

(52) U.S. Cl. 290/44; 244/155 A; 290/55

(57) ABSTRACT

The present disclosure provides a method and system for altering the drag force on a wind capturing structure. First, the present disclosure implements a new bridle system. Mainline 70 attaches to the bridle of kite 72, which consists of two bridle lines 74 and 76 joined at single point 78 at the top of the kite, and two separate points 80 and 82 at either side of the bottom of the kite. Mainline 70 wraps around the two bridle lines with sliding mechanism 84; sliding mechanism 84 may be able to slide up and down the bridle lines 74 and 76 like a bolo. The present disclosure also presents unpowered, automatic, and powered sliding mechanisms which may alter the lift and drag forces on the wind capturing structure.

### CROSS-REFERENCE TO RELATED APPLICATIONS

This application is a continuation-in-part of U.S. patent application No. 12/188,867 entitled “SYSTEM AND METHOD FOR HARNESSING WIND POWER AT VARIABLE ALTITUDES” filed Aug. 8, 2008.

### TECHNICAL FIELD

The present invention relates to devices that alter drag and lift forces on a structure harnessing wind energy—more specifically to devices that alter tethered kites used to extract power from the wind.

### BACKGROUND

The kite is a very old technology, and has been used for centuries as entertainment and as a common toy. More recently, kites have been used to help tow many different types of vehicles, from skateboards and surfboards to boats.

Typically, kites are used close to the ground, and are controlled by multiple lines operated by one person. This environment has variable wind conditions, as well as inconsistent direction and intensity. The environment near the ground is not financially and operationally practical for sustainable and effective power production.

A basic reason a kite system may be operationally impractical in an environment away from the ground is that the materials used to manufacture the kites have developed slowly. Combining new materials and techniques with old technologies to construct kites capable of larger drag and tensile forces may be needed to progress this technology. With new materials the kites could be operated in more extreme environmental conditions as well as further away from the surface, thereby increasing production. Kite system safety measures are another area where development has been slow. A kite elevated in the atmosphere could be an obvious discharge point for lightning and static electricity. Anchoring a kite that is in extreme wind conditions also requires attention. Broken lines and lost kites are not only expensive, but may be dangerous.

Related art, such as U.S. Pat. No. 3,924,827, entitled “APPARATUS FOR EXTRACTING ENERGY FROM WINDS AT SIGNIFICANT HEIGHT ABOVE THE SURFACE” and U.S. Pat. No. 4,076,190, entitled “APPARATUS FOR EXTRACTING ENERGY FROM WINDS AT A SIGNIFICANT HEIGHT ABOVE THE SURFACE” by Lambros; U.S. Pat. No. 4,124,182, entitled “WIND DRIVEN ENERGY SYSTEM” by Loeb; U.S. Pa. No. 6,254,034, entitled “TETHERED AIRCRAFT SYSTEM FOR GATHERING ENERGY FROM WIND” by Carpenter; U.S. Pat. No. 6,523,781, entitled “AXIAL-MODE LINEAR WIND-TURBINE” by Ragner; and U.S. Pat. No. 7,188,808, entitled “AERIAL WIND POWER GENERATION SYSTEM AND METHOD” by Olson all describe methods of capturing wind using an elevated device. Inherently each disclosure is also very complicated and not functional in producing efficient power.

There is a need for a wind power system and method of operation that allow financially and operationally practical use of such systems for sustainable and effective power production at variable altitudes.

A further need exists for kites and kite systems employing materials that allow their operation in more extreme environmental conditions to support the sustainable and effective generation of electrical power through wind energy conversion processes.

A further need exists for a kite system and methods of their operation that are electrically and mechanically safer than known kite systems.

### SUMMARY

The presently disclosed subject matter includes a system and methods of operation of said system for generating electrical power from wind using a wind capturing structure lofted into faster wind currents. An exemplary embodiment could have a wind capturing structure for creating a force operable over a wind range of 2 m/sec to 20 m/sec, and lines of at least 250 kN*m/kg strength to density ratio attached to the wind capturing structure. The preferred embodiment may be operated over any wind speed, and may be calibrated to maximize operation particular to the location. The lines could be let out, generating linear motion. An axis of rotation could be central to the system, and the lines could rotate in any direction (depending on the wind) around this axis. A winding structure on the axis of rotation could be used to wind the lines and for transforming the linear motion into rotational motion. A retractor attached to the winding structure could be used to rewind the lines from one predetermined length to a second predetermined length of shorter magnitude. Finally, a generator could be coupled to the winding structure for converting the rotational motion into electrical power.

Preferred features for the wind capturing structure may include being effective in downwind power generation, durable in high winds, lightweight, inexpensive, safe in the event of a crash, and easily modified to reduce lift and drag for retraction.

In a preferred embodiment, the wind capturing structure may be a kite; a sparless kite, a bridleless kite, a single skin kite, a parawing kite, a sail wing kite, a Rogallo kite, a low line angle kite, a high angle of attack kite, a low lift/drag ratio kite are all possible kites that could be used in the system, but new developments may also be better options. The capturing structure may be capable of creating lift in a low altitude environment, and capable of operating in high wind conditions.

An exemplary embodiment may have a minimum plurality of lines with a strength to density ratio of at least 250 kN*m/kg, which may be constructed of carbon nanotubes, carbon fiber, Ultra High Molecular Weight Polyethylene (UHMWPE) synthetic rope, Cuben Fiber, Plasma®, PBO, Kevlar®, Aramid®, M5®, Zylon®, braid optimized for bending (BOB), a hybrid rope, which all have been shown to have high specific strengths. The lines are constructed with minimal mass to permit lift of said wind capturing structure at low altitudes, and are constructed with maximum tensile strength to prevent failure in high wind environments. In a preferred embodiment, the lines that control the wind capturing structure could not slip on the spool during normal operation.

The winding structure may be a spool, spindle, reel, coil, or any structure capable of rotating about an axis. The preferred embodiment could also minimize energy losses in the system for maximum efficiency.

A versatile wind capturing structure could include a kite operable in variable conditions for efficient and consistent production of force, lines with a minimum tensile strength to density ratio 250 kN*m/kg for linear motion generation, a velocity controller for controlling the rotational motion and the linear motion, and lift and drag force controller for adapting the kite's lift and drag coefficients and/or cross-sectional area (also referred to as “reference” area) for optimizing power output and/or input. The versatile wind capturing structure may be adaptable by lift and drag controller and velocity controller. Control via the lines allows for the entire system to be efficient and consistently generate force for power production. An exemplary embodiment of velocity control may be accomplished by altering a load upon a generator. Similarly, the velocity could be controlled by altering the lift and drag forces of the wind capturing structure. Altering the lift and drag force could be accomplished by folding, deforming, re-orienting, or some other means of reducing lift and drag on the wind capturing structure.

The power producing cycle of a system generating electrical power from wind has the steps of unwinding the winding structure to create linear motion for producing rotational motion, coupling the winding structure to a generator for power production, slowing down the linear motion, reducing the lift and drag for retrieval, altering the winding structure to operate in reverse for retrieving the system, and starting the cycle again. The retrieval energy used should be kept to a minimum to maximize the efficiency of the system.

These and other advantages of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages included within this description be within the scope of the accompanying claims.

### BRIEF DESCRIPTION OF THE DRAWINGS

For a more complete understanding of the features and advantages of the present disclosure, reference is now made to the detailed description of the invention along with the accompanying figures in which corresponding numerals in the different FIGUREs refer to corresponding parts and in which:

FIG. 1 is a diagram of the forces which act upon a kite system in flight;

FIG. 2 is a diagram of one embodiment of the present disclosure, showing the different components;

FIG. 3 is a diagram of one embodiment of the present disclosure showing a more intricate view of several components; and

FIGS. 4A and 4B are diagrams of one embodiment of the present disclosure transitioning from extraction to retraction.

FIG. 5 shows an embodiment of a sliding mechanism.

FIG. 6 provides an illustrative drawing of a sliding mechanism.

### DETAILED DESCRIPTION

While making and using various embodiments of the present disclosure are discussed in detail below, it should be appreciated that a preferred embodiment provides many applicable inventive concepts, which may be embodied in a wide variety of specific contexts. The specific embodiments discussed herein are merely illustrative of specific ways to make and use the present disclosure and do not delimit the scope of the present disclosure.

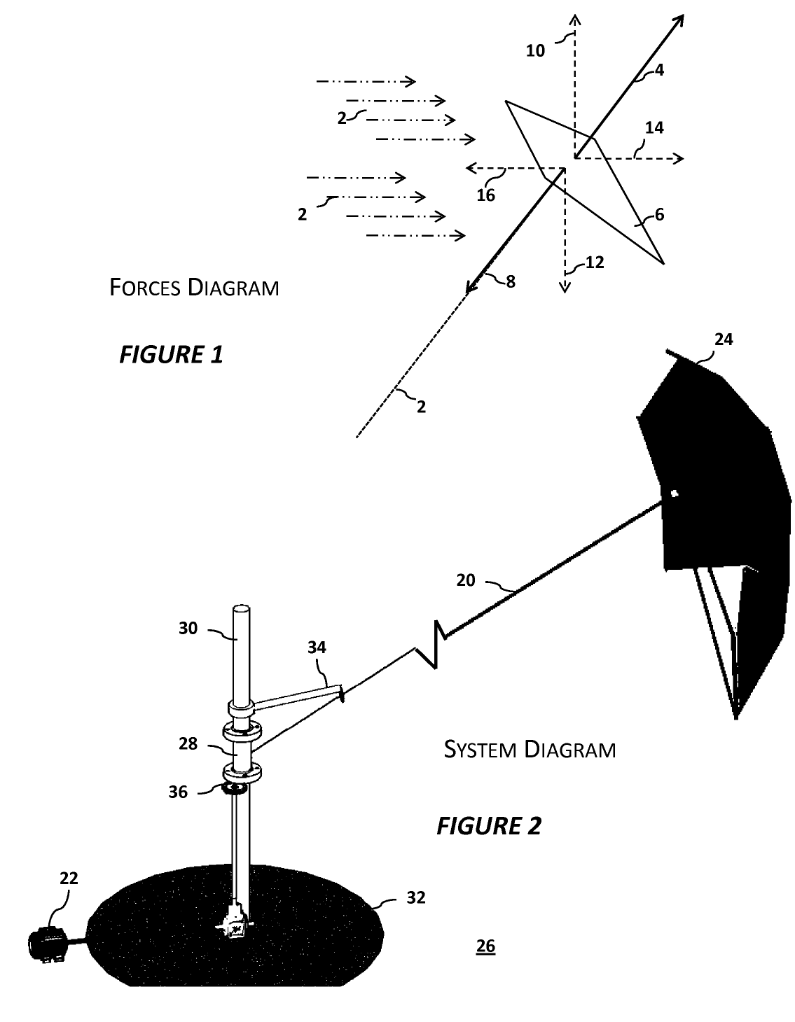

The present disclosure involves using a wind capturing structure (a kite) to power a system that produces electrical energy in the most simple and efficient way. FIG. 1 shows that the system relies on wind 2 causing wind force 4 on kite 6. Kite 6 remains in flight by flying at an angle to the anchor (in recreational kites, the anchor may be the user); wind force 4 occurs in the opposite direction of the anchoring line 8. To be effective, wind force 4 must create enough force that vertical wind force component 10, referred to as “lift” is equal to or greater than downward force component of the line 12 plus the weight of the kite 6. Normally, horizontal wind force component 14, referred to as “drag”, cancels with the horizontal force of the line 16(equal and opposite in direction), and the kite may be stationary. However, in the power generating system, drag 14 may be still equal to the horizontal line force during the outbound phase, but the system allows motion to be generated. Force 4 decreases during the inbound phase, which also decreases force 8 making retraction easier.

For a moving kite, line tension (rope tension) may be equal to power generated divided by the outbound kite speed. For a stationary kite, line tension may be equal to the net components of lift plus drag that are parallel to the line, which may range between approximately one to the square root of two (√2) times the drag force, while line angle ranges between 0° and 45°. Total drag may be equal to 0.5*Air density (1.2)*velocity2*kite area*drag coefficient (about 1.42 for a Rogallo kite)

$${F}_{drag} = 1 / 2 ⋆ {ρ}_{air} ⋆ {u}^{2} ⋆ {A}_{kite} ⋆ {C}_{d} \\ {C}_{d} \approx 1.42 \\ {ρ}_{air} \approx 1.2$$

where,
ρPₐᵢᵣ=Density of Air
Aₖᵢₜₑ=Area of Kite
F_{drag}=Drag Force

At a 45 degree line angle, lift force ≈ drag. Therefore, roughly, this number must exceed the weight of the kite and extended line to stay aloft. A lightweight line would be ideal, however, the same line must be strong enough to harness the higher wind speeds. The combined vectors of the two equal forces acting parallel to the line may be equal to √2/2* drag. This gives equations (1) and (2) providing the minimum necessary strength to weight characteristics of the line:

Tensile strength*cross sectional line area>√2/2*0.5*1.2*VMax̂2*reference area*1.42 (1)

gₙ*Line density*cross sectional area*length<0.5*1.2*VMin̂2*reference area*1.42 (2)

Solving for strength to weight ratio, or specific strength, of the line gives:

Tensile Strength(N/m̂2)/Density(kg/m̂3)>1.414213562*Total Length (m)*9.80665(M/ŝ2))*(Maximum wind speed (m/s)̂2/Minimum wind speed (m/s)̂2)

or

σ_{UTS[N/m}²]/ρ[kg/m³]>√2*gₙ[m/s²]*L[m]*Uₘₐₓ²[m/sec²]/Uₘᵢₙ²[m/sec²]

where,
σ_{UTS}=Tensile Strength
gₙ=Standard gravity
U=Wind Velocity

Likewise, the minimum wind speed in which a given line may be used to keep a kite aloft is: Minimum wind speed=√(√2*((Line weight+kite weight)*Maximum wind speed²)/Breaking Strength):

Uₘᵢₙ=√(√2*(Wₗᵢₙₑ+Wₖᵢₜₑ)*(Uₘₐₓ²)/σ_{BS})

where,
Wₗᵢₙₑ=Line Weight
Wₖᵢₜₑ=Kite Weight
σ_{BS}=Breaking Strength

In many areas, wind speed increases significantly upon reaching an altitude of 300 m. Since line angle is assumed to be approximately 45°, this gives a line length of 300/(sin 45°)=424.26 m. In order to not involuntarily fall from this minimum wind window, the kite must be able to stay aloft in the minimum winds typical for this altitude. A liberal estimate is 3 m/s.

Power production increases with a higher peak wind speed harnessed. For optimal performance, the particular maximum wind speed may be at least 20 m/s. To operate under these conditions requires a line with a specific strength of:

=√2*424.264068[m]*9.80665[m/s²]*((20[m/sec]))²/(3[m/sec]))²)=261,511 N*m/kg

A wind power generation system includes a kite that moves outbound for a distance semi-parallel to the ground, then may be retracted for a distance using less force, and then cycles to outbound movement again. Energy may be generated on the outbound stage. During the inbound, or retraction, phase the kite may be made to use less force by either modifying the position, modifying the shape or aerodynamic properties, or by using lift to fly back inwards. The modification of the kite during this phase may be accomplished by either a remote signal to a device on the kite, a secondary signal line, a secondary main line, a signal sent up the main line (such as a tug), or an automatic detection by a device on the kite.

FIG. 2 shows a kite electrical power system consisting of single line 20 that turns generator 22, attached to kite 24 moving at a low angle from ground 26. Kite 24 may be one that maximizes lift +drag per surface area, with the only lift requirement that the kite generates enough during the outbound and inbound states to stay aloft.

Line 20 may be attached to spool 28 on robust vertical axle 30 fixed in concrete ground anchor 32, vertical axle 30 and ground anchor 32 are not affected by wind direction. This spool 28 allows 360 degrees of operation of kite 24. Separate guide 34, which rotates independently around the axle above the spool, keeps the line properly aligned on the spool and may prevent slippage.

Beveled gearing system 36 connects spool 28 to detached generator 22. Gearings system 36 includes safety measures so that a failure along spool 28 may not damage generator 22.

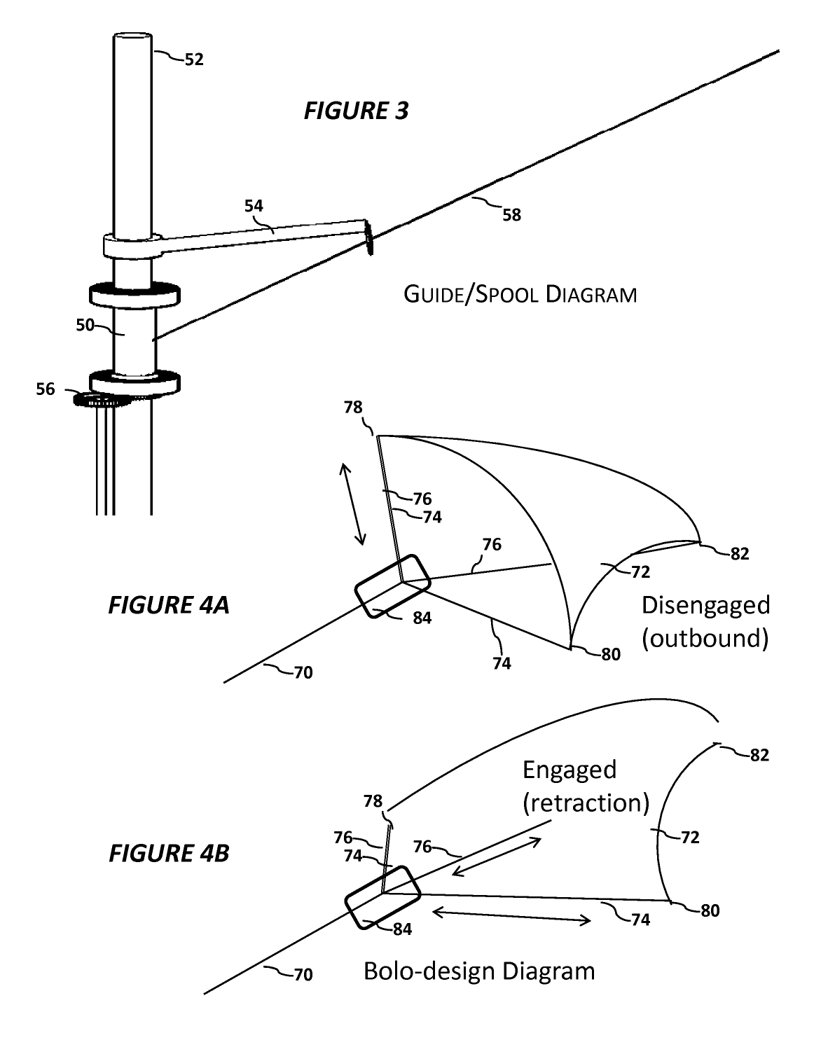

A more intricate figure of this embodiment is shown in FIG. 3. Spool 50 may be on central axis 52. Axis 52 may be vertical so that the wind may change direction without affecting the system's operation. Guide 54 also rotates according the wind direction, and aids in the successful winding and unwinding of spool 50. Finally, the start of gearing system 56 may be below spool 50. Although gearing system 56 may not rotate around axis 52, it may be unaffected by wind direction. Gearing system 56 may have multiple functions including, but not limited to, supplying the rotational motion to the generator, insulating critical components from static and electrical spikes, simplifying maintenance, and may be used in reversing the system, and/or continuous variability to control rotation speed.

The system may further include a clutch coupled to the gearing system. The clutch could be able to transition the winding structure into a retracting phase. Also, a flywheel may be included. The flywheel could be capable of absorbing excess energy and momentum. Momentum could be conserved, and energy may be stored mechanically in the events of excess energy, such as gusting conditions, or high winds. The clutch could engage the flywheel when necessary, both to absorb energy and to return energy to the system if it was needed.

FIGS. 4A and 4B show mainline 70 attached to the bridle of kite 72, which consists of two bridle lines 74 and 76 joined at single point 78 at the top of the kite, and two separate points 80 and 82 at either side of the bottom of the kite. Mainline 70 wraps around the two bridle lines with sliding mechanism 84; sliding mechanism 84 may be able to slide up and down the bridle lines 74 and 76 like a bolo. A sheath (not shown) or other abrasion resistant coating may protect lines 70, 74 and 76 from damage caused by sliding mechanism 84. A locking spring-loaded mechanism exists on either side of the sliding mechanism 84. While outbound, upon receiving a sudden jerk from the mainline, the mechanisms unlock and the springs may attempt to slide the sheath upwards along the bridle. The bolo layout may naturally force the mechanisms and sheath upwards, which changes the “center of force” on the kite from the middle of the curved surface to a position more to the leading edge. This flattens the kite, largely reducing the lift and drag. The mechanism may store spring energy, possibly in a torsion spring, on the upwards trip. Once at the top of the kite, the kite may flatten out and retract easily. Once retracted, tension may be let up on the line, and the spring mechanisms slides the sheath downward along the bridle. This may pull the kite back into position for outbound travel by shaping the kite aerodynamically and altering the angle of attack.

The bolo configuration may also force the sheath to slip upwards if the force on the system exceeds a certain threshold. This may happen automatically after wind speed reaches a certain level. Other possible mechanisms used in the sheath include but are not limited to compressed air, pistons and/or motors.

A number of exemplary mechanisms may provide sliding capability to sliding mechanism 84. Sliding mechanism 84 may be powered, unpowered, and/or automatic.

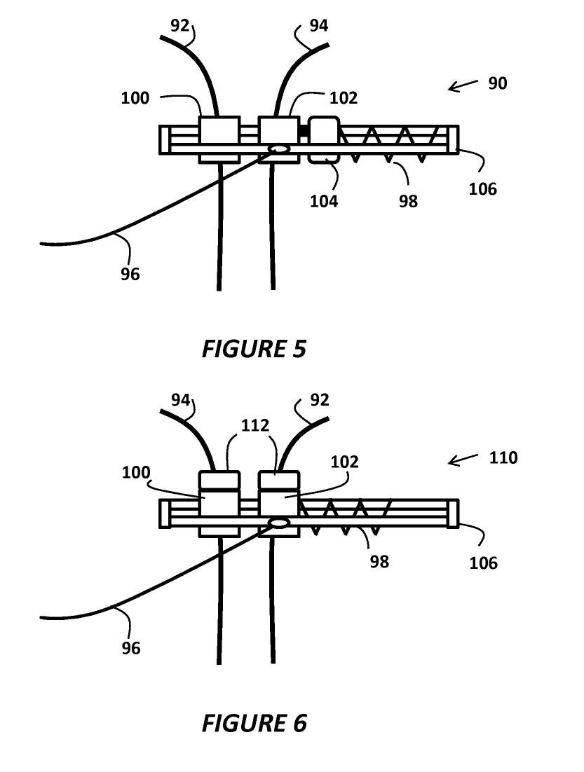

FIG. 5 shows exemplary unpowered sliding mechanism 90. Sliding mechanism 90 includes two rollers 100 and 102 attached to two bridle lines 92 and 94. In this case, roller 100 attaches to bridle line 92 and roller 102 attaches to bridle line 94. Ratchet and pawl 104 lock rollers 100 and 102 in place. Torsion spring 98 stores energy when sliding mechanism 90 moves away from a baseline position on bridle lines 92 and 94. Brace 106 may be used to secure the components of sliding mechanism 90. Ratchet and pawl 104 may be released by a signal, such as a sharp tug from main line 96. Other lines (not shown) could also be used to release ratchet and pawl 104. For example, an auxiliary signaling rope could be used to release ratchet and pawl 104.

After a signal releases ratchet and pawl 104, sliding mechanism 90 adjusts its position based on the combination of force from torsion spring 98 and forces from bridle lines 92 and 94. For example, if wind forces force apart the bottom anchors of bridle lines 92 and 94, the pulling action on bridle lines 92 and 94 will exert an upward force on sliding mechanism 90.

In an exemplary automatically adjusting version, ratchet and pawl 104 on sliding mechanism 90 may slip upwards or downwards if forces vary from a certain value; or, ratchet 104 may release if the tension on bridle lines 92 and 94 varies from a certain value. This could cause sliding mechanism 90 to slip upwards if, for example, the upwards force exceeded a certain value due to excessive wind. Alternatively, it could cause ratchet and pawl 104 to release and sliding mechanism 90 to move fully upward to the retraction position if the force on bridle lines 92 and 94 decreased past a certain value, indicating diminishing wind.

FIG. 6 shows sliding mechanism 110 having substantially similar components of sliding mechanism 90. However, ratchet and pawl 104 are removed and locking devices 112 are added. Rollers 100 and 102 may be held in place by locking devices 112. Locking devices 112 may be a device for applying a frictional force to rollers 100 and 102. For example locking devices 112 may be any of a frictional break, a frictional torque limiter or clutch, or a torque limiter sprocket. Locking devices 112 may use other devices for locking rollers 100 and 102 known to those having ordinary skill in the art.

Rollers 100 and 102 may be held in a given position by frictional forces of locking devices 112, such as a frictional break grabbing the bridle lines, or a frictional torque limiter or clutch, or it may be held in place by an opposing force placed by torsion spring 98. These forces can be calibrated to be overcome should the forces on the kite exceed certain boundaries. For example, a torque limiter sprocket, a device calibrated to slip if the torque on the sprocket exceeds a precise value, may be used for locking devices 112. Similarly, rollers 100 and 102 may slip if the force on them exceeds a certain value.

In one embodiment, rollers 100 and 102 would be calibrated to slip upwards once the upwards force produced by bridle lines 92 and 94 being driven outwards indicated that the wind force exceeded a safe value. Slipping upwards would move the kite into a safer position catching less wind (lower angle of attack and reference area). Alternatively, locking devices 112 could be attached to a tension switch (not shown) that would trigger once main line 96 force exceeded a certain level and unlock devices 112, sending rollers 100 and 102 upwards to their terminal position and positioning the kite for easy retraction.

In another embodiment, sliding mechanism 84 (FIG. 4a) may automatically adjust to varying line tensions, wind conditions, and/or power production considerations. A sensor or other electronic device could unlock ratchet based on line tension, wind conditions, and/or power production considerations. These conditions may be preprogrammed into the sensor. Further, the sensor could be used to control the amount or distance sliding mechanism slides along bridle lines 74. This control could take many forms. In one embodiment, a preprogrammed rate of sliding controls sliding mechanism 84 based on a certain criteria. In another embodiment, a feedback control circuit controls sliding mechanism 84.

Sliding mechanism 110, for example, can also be electronically switched or use electronically controlled clutches, allowing for a controlled trigger or tensioning. Electronic controls would allow for more sophisticated measuring of variables, including above and below tensions in all bridle ropes, mainline tension, angle of attack, and line angle, and could release or trigger a lock, or vary the tension or torque limitation of spring devices. Electronic control could be used with a powered device as well, allowing for precision placement of the slider device along the bridle ropes by on board motor control.

Although a torsion spring has been used in the examples above, other devices may also be used to provide sliding action to sliding mechanism 90. For example, a hydraulic piston, pneumatic piston, or a motorized device may be used to store energy once sliding mechanism 90 moves away from a baseline position. Further, sliding mechanism 90 may be used to adjust the line tension of a variety of wind capturing structures not limited to the bolo configuration described heretofore.

Further, the above referenced sliding mechanisms may be altered according to the knowledge of those having ordinary skill in the art without departing from the scope of the present disclosure. For example, locking devices 112 may be placed below rollers 100 and 112 instead of above as shown in FIG. 6. Further, other sliding devices, besides rollers 100 and 102, may be used to adjust line tension.

Kite angle may be another contributing factor to force generation. Typically, kites are designed to fly at as high an angle as possible; however, the present disclosure may utilize kites that fly at lower angles. The horizontal drag force, referenced as “drag”, becomes larger as the angle decreases from 90° (straight up) to 0°. Equal lift and horizontal force produce a line angle of approximately 45°. An optimal operating line angle may be slightly less than 45° from the horizontal axis in an exemplary embodiment.

The true optimization equation for line angle may be a complicated equation involving integrating the wind power over the altitude range of operation. However, assuming approximately equivalent speeds over the entire range, the efficiency equation maximizes at the lowest possible line angle. Other extensions of this optimization take into account line cost versus increased efficiency cost.

Lₗᵢₙₑ=Height/sin (θₗᵢₙₑ)

A decrease in line angle results in an increase of line length of:

Range/sin (θ_{line[1])-Range/sin (θ}_{line[2]})

To accomplish flight at a varying angle, the bridle lines need to be altered. Flight at a low angle may produce a higher force from lift+drag, and the path of flight may be lengthened, minimizing the effect or ratio of “time lost” when flipping the kite.

Decreasing line angle also has a correlation with increasing the angle of attack. Increasing the angle of attack will typically increase the reference area of the kite, further increasing the total force generated on the kite.

Finally, the lift and drag coefficients and the effective area of the kite may determine how much force may be generated as a function of the wind speed squared, and the density of the fluid (in this case atmospheric air). The lift and drag coefficients may be determined by the shape, rigidity, permeability and orientation of the kite relative to the flow. Altering these coefficients, with methods such as the previously mentioned bolo, may also determine how much energy may be required to retract the structure back to its starting point. The system should minimize lift and drag while maintaining flight during this phase for maximum efficiency in the overall system.

Additional methods to reduce lift and drag include folding, and re-orienting the kite so that it presents new features in this different state. Folding the kite again may reduce the cross sectional area that may be exposed to the flow.

Re-orienting the kite changes the profile of the kite with relation to the flow. This may alter the drag and lift coefficients. With the correct profile pointed into the flow, the kite may move at an angle into the flow. This may be similar to a sail boat that uses the airfoil to drive the boat. A sail boat may be driven in any direction with the exception of 45° of directly into the wind, leaving 270° of available tracking direction. Moving angularly to the flow could significantly reduce the required energy to retrieve the wind capturing structure.

The kite travels back and forth between an optimized minimum (for example 300 meters) and a maximum (for example 400 meters) in a flat rural area, complying with any regulations for the airspace for that region, but operating in a local maximum for wind speed and consistency. Wind speeds and consistency are variable according to location, but the system may be optimized based on the chosen location. The same criteria may be used for any night time drop off in winds. The system may be designed to maximize efficiency over the entire year, as well as minimize potential “crash events”. Outbound travel time and speed may be a function of wind speed. Inbound speed may be largely constant at 20 m/sec or more.

Efficiency of the system may be measured using the following equation. Efficiency=(time generating/(time generating+time retracting+time transitioning))*((energy generated−energy consumed)/(energy generated)). For example, 30 seconds of outbound motion yields 1000 joules of energy; then, 30 seconds of retraction requires 500 joules of energy. Efficiency may equal (30/60)*((1000−500)/1000), yielding an efficiency of 0.25.

Eff=(tᵤₚ/(tᵤₚ+t_{down})*((Eᵤₚ−E_{down})/(Eᵤₚ))

where,
tᵤₚ=Time spent in upward flight (extension)
t_{down}=Time spent in downward flight (retraction)
Eff=System efficiency
Eᵤₚ=Energy in upward flight
E_{down}=Energy in downward flight

In an exemplary embodiment, the kite flies from 300 meters to 400 meters at an angle of 30°. The total distance traversed may then be 183 meters (182.88). At a wind speed of 10 m/sec, the kite may move outwards at 5 m/sec, taking it 36.576 seconds to travel the entire distance. A generous ceiling for kite flattening time may be the time it could take the tail of the kite, moving in an arc, to travel to be parallel with the wind. If the height of the kite may be 30 meters, the arc may be approximately equal to ¼*(n*2*30 meters)=¼*188.5=47 meters. At 10 m/sec, this may be equal to 4.7 seconds. This time may be exaggerated; the present embodiment could take much less time. At the end of the retraction phase, the front end of the kite must again move to be perpendicular to the wind, which should take the same amount of time, another 4.7 seconds. If the kite were retracted at 10 m/sec, this could take 18.288 seconds. Thus the total time during retraction may be 27.688 seconds, giving a maximum efficiency of 57%.

Outbound speed and line tension are inversely related. Both are varied automatically to maintain the optimal angle and maximize the fluid dynamics equation for kite speed vs. wind speed. Line tension may be controlled at the generator level by varying generator load.

Outbound speed and line tension are inversely related. Both are varied automatically to maintain the optimal angle and maximize the fluid dynamics equation for kite speed vs. wind speed. Line tension may be controlled at the generator level by varying generator load.

Expended line and line angle may be monitored. The system automatically retracts based on a combination of these factors indicating reaching the ceiling, or cycle time, or upon line termination. The kite may be also automatically retracted if line tension falls below a certain threshold.

Kite power may be made difficult by the need to be able to withstand strong winds at higher altitudes while being lightweight enough to create lift in lighter conditions and to be lightweight enough to be launched in the lower wind conditions of lower altitudes. The limiting factor currently in this system may be line weight, not kite weight. The minimum for practical use of a kite power system in most areas may be a specific strength (tensile strength/density ratio) of approximately 250,000 (N*m/kg).

Materials such as carbon nanotubes, carbon fiber, UHMWPE synthetic line, Cuben Fiber, Plasma, PBO, Kevlar, Aramid, M5, Zylon, and braids may be used to construct the line in the present disclosure. An exemplary UHMWPE line made of Spectra has a specific strength of 1,380,000 N*m/kg, which satisfies the requirements of the system.

The anchoring platform for the system may be very robust. It may need to be constructed to withstand the forces, moments, and stresses produced by the kite. Generator size per meter of kite collection area may be an optimization problem based on wind power distribution of the area.

For a site containing above average wind velocities, optimal generator size may be about 2500 watts per square meter of kite collection area. The optimal amount of power to be harnessed may be some amount lower than the peak power generated by the wind in a region. Optimization may be simplified by minimizing the cost/power ratio given the cost of the kite, line, and generator necessary to harness a given power and the wind power available in a specific region.

In an exemplary embodiment where the average wind power for an area is 400 watts/m² and the peak power is 4000 watts/m², the maximum power able to be harnessed may be set at 1000 watts/m². Cost per area for kite may be fixed at approximately $50/m². Cost per area for line may be length (800 m*240 N of force/m @ 1000 watts* $0.000058/m/N=$11.14/m². Cost per generator may be $0.05/watt=$50/m². This gives a cost of $111.14/m². One may then calculate using the actual amount of energy that could be generated by this system and may calculate the amount money generated per area. The number may then be recalculated for increased generator and line sizes. The optimal number maximizes the ratio of profit/cost per area.

In the instantaneous mechanical model, the impact of the wind against the kite may be approximated as a series of elastic collisions. In this case, energy transfer to the kite may be maximized when the kite may be moving at 50% of wind speed, and transfer efficiency may be 100%. However, other methods may be used to more accurately optimize the entire system. Once kite speed increases above zero, the rate of molecular impacts onto the surface decreases. Taking this into account, a more accurate calculation maximizing the force on the kite times the kites outbound speed indicates an optimal kite speed equal to ⅓ (33%) wind speed.

Stability and predictability in the system are important when optimizing the system. Extraction at ˜33% of the wind speed optimizes simple mechanical power generation. Smooth operation however provides both power generation and stability. Therefore several methods are used to give smooth operation at approximately 33% extraction, such as an active generator. An active generator may vary resistance with changes in wind speed, and spikes in wind as discussed before. Also, operating at the currently disclosed altitude largely reduces turbulence issues associated with the boundary layer of fluid flow.

Safety may be another important consideration in the present embodiment. Minimizing dangers to persons around the system, the environment, and to the system itself are all addressed to maximize cost efficiency and minimize risks.

Static electricity and lightning strikes are going to be important safety considerations, and likely may be common with the system. Several features may be included in the system to prevent danger to humans, equipment, and the grid. First, the kite may be made of poorly conductive and flame retardant materials. Second, the lines may be poorly conductive as well; this may ensure that any lightning that strikes the kite may not be transferred to the ground via the lines. The power/generating equipment may also be separated from the kite anchor, and use insulated mechanical devices (gears, shaft, etc.) to connect to the anchor. Prior to sensitive electrical equipment, lines may be attached to a grounding system, which may effectively operate as a lightning rod and grounds the circuit.

There are several other safety measures designed into the system. First, a fault line may be used to prevent catastrophic failure during high winds or gusts. The fault line may be designed to be the weakest line, and may break first in the event of excessive wind force. Without the fault line, the kite may no longer produce enough lift to continue operation, at which time emergency winding may occur. The kite may be able to sustain enough lift for the kite to be recovered without crashing.

A similar method may be used in the case of unexpected lull in winds. In an exemplary embodiment, the system may operate within the wind speed range of 2 m/sec to 20 m/sec. However, if the wind decreases to 0.5 m/sec, then the generator may wind the system in at 1.5 m/sec. This may give the system the required 2 m/sec wind to create appropriate lift while retraction occurs, and may prevent the kite from crashing. Additionally, winding in the kite reduces the weight of the expended line, decreasing the minimum wind speed for the kite.

Another safety measure may be automatic adjustment of the kite to prevent shock failure. The kites may be able to flatten in the event of a wind spike, or gust, and then be able to recover previous shape to continue operation. This again may prevent crashes.

As well, the equipment on the ground may have safety measure to prevent failure. Besides the before mentioned insulation, the generator may have the ability to slip to adjust to unsafe events. This may reduce the tension on the lines, and the torque on the anchoring system. Force on the kites may also lessen.

Related prior art of the present disclosure do not address many of the difficulties of wind powered energy generation. Namely the complexity of controlling the system, and inefficiencies in the system. Weight may be a major concern, and most of the weight in a system may be in the lines. Therefore minimizing the number of lines may increase the system's efficiency. Prior art does not address the materials and methods to be used to fix this problem.

A second way to decrease weight and increase cost effectiveness may be to simplify the system. For example, U.S. Pat. No. 6,523,781 and U.S. Pat. No. 7,188,808 must have fully rotatable housing platforms. This housing platform must contain the gearing system, the generator, and anchoring systems, making it a substantial engineering feat. The present disclosure eliminates the need for a large housing platform by its robust vertical axis with fully circular spool. In this way the wind may blow any direction, and the large components (gearing system, generator, etc.) do not need to move.

Secondly, prior art always has a way to decrease the effectiveness to prevent damage to the system, such as U.S. Pat. No. 6,523,781 changes the pitch angle and release rate of the lines to stay within in a range that the system may handle. The present disclosure improves on the system by using this energy in other ways, and still safely operating. With the increased strength of materials used in the kite, the stresses of higher wind speeds are expanded, and instead of dissipating the energy, the present system utilizes other properties such as a clutch and a flywheel to use the extra energy in a different way. This ability to convert excess energy increases the overall efficiency of the present embodiment.

Many of the prior art require inflation of components of their systems with “lighter than air” gases to help create lift and sustain flight. The present disclosure does not require such features, nor the technology required to give the system that capability. There exist many modes of failure and added complexity associated with the ability to pump a gas along a suspended line. Secondly, several hundred feet of tubing required to transport the gases from the ground to the launched system may add weight to the system, further decreasing its efficiency. U.S. Pat. No. 6,523,781 solves this problem by permanently inflating the airfoil. However, permanent inflation in a dynamic environment could require extensive maintenance, and has the risk of failure. The failure places the entire system at jeopardy, as well makes the area around the system unsafe.

The present disclosure solves many of the engineering conflicts of prior art by using new materials not previously available, and simplifying their use into an efficient system.

The structural and operational features and functions described herein for sustainable, efficient, and consistent wind power generation may be implemented in various manners. The foregoing description of the preferred embodiments, therefore, is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A wind-based power generation system comprising a bridle system for optimizing power production, the wind-based power generation system comprising:
a wind capturing structure operating in association with a ground-based power production system for converting wind force to electrical power;
a bridle system for controlling lift and drag forces associated with said wind capturing structure for optimizing production of said electrical power, said bridle system comprising:
at least three lines associated with said wind capturing structure, wherein said at least three lines comprise at least two bridle lines for attaching to at least three positions on said wind capturing structure and at least one base line for coupling said wind capturing structure to said ground-based power production system; and
a sliding mechanism associated with said at least two bridle lines for altering drag and lift forces of said wind capturing structure, said sliding mechanism's position altering the line tension of said at least two bridle lines.

2. The system of claim 1 wherein said sliding mechanism further comprises an automatic slider, said automatic slider capable of sliding said sliding mechanism automatically.

3. The system of claim 1 wherein said sliding mechanism further comprises an unpowered slider.

4. The system of claim 1 wherein said sliding mechanism is associated with said at least one base line, said sliding mechanism capable of altering the angle of attack of said wind capturing structure as a result of said sliding mechanism's position relative to said at least two bridle lines and at least one base line.

5. The system of claim 1 wherein said sliding mechanism further comprises a sheath, chafe guard, jacket, wire braid, and/or protective coating around at least one of said at least three lines, said sheath, chafe guard, jacket, wire braid, and/or protective coating protecting at least one of said at least three lines from damage caused by said sliding mechanism.

6. The system of claim 1 wherein said sliding mechanism further comprises a torsion spring, hydraulic piston, pneumatic piston, and/or motorized device.

7. The system of claim 1 wherein at least one of said at least three lines further comprise a metal cable, reinforced rope, fiber core wire rope, and/or other abrasion resistant line.

8. The system of claim 1 wherein said wind capturing structure further comprises a sparless kite, a single skin kite, a parawing kite, a sail wing kite, a Rogallo kite, a low line angle kite, a high angle of attack kite, or a low lift/drag ratio kite.

9. A method for enhancing the power production capabilities of a wind capturing structure for use in conjunction with a ground-based power system, the method comprising the steps of:
elevating a structure;
automatically activating a mechanism in association with said structure for altering the drag and lift forces of said structure;
altering the drag and lift forces of said structure, said mechanism altering the shape, orientation, and/or some other structural feature of said structure;
maintaining the altered shape, orientation, and/or some other structural feature of said structure; and
deactivating said mechanism such that said structure returns to original drag and lift forces.

10. The method of claim 9 wherein the step of automatically activating said mechanism further comprises the step of automatically activating an unpowered mechanism.

11. The method of claim 9 wherein the step of automatically activating said mechanism further comprises the step of automatically activating said mechanism based on safety considerations.

12. The method of claim 9 wherein the step of automatically activating a mechanism further comprises the step of automatically activating said mechanism based on power production considerations.

13. The method of claim 9 wherein the step of automatically activating said mechanism further comprises the step of automatically activating said mechanism based on wind conditions.

14. The method of claim 9 wherein the step of altering the shape, orientation, and/or other structural feature further comprises the step of adjusting the tension of at least one base line and/or bridle line associated with said structure.

15. The method of claim 9 further comprising the step of detaching at least one line of said structure for reducing the lift and drag forces of said structure.

16. The method of claim 9 wherein the step of altering the drag and lift forces of said structure further comprises the step of raising an angle of attack of said structure.

17. The method of claim 9 wherein the step of altering the drag and lift forces of said structure further comprises the step of lowering an angle of attack of said structure.

18. A wind-based power generation system comprising a bridle system for optimizing power production, the wind-based power generation system comprising:
a wind capturing structure operating in association with a ground-based power production system for converting wind force to electrical power;
a bridle system for controlling lift and drag forces associated with said wind capturing structure for optimizing production of said electrical power, said bridle system comprising:
at least two lines associated with said wind capturing structure, said at least two lines comprising at least one bridle line and at least one base line coupling said wind capturing structure to said ground-based power production system; and
an automatic sliding mechanism for automatically adjusting line tension of said at least one of said at least two lines based on wind conditions, line tension, line length, safety conditions, and/or power production conditions.

19. The system of claim 18 wherein said automatic sliding mechanism further comprises a torsion spring, hydraulic piston, pneumatic piston, and/or motorized device.

20. The system of claim 18 wherein said automatic sliding mechanism further comprises a sheath, chafe guard, jacket, wire braid, and/or protective coating around at least one of said at least two lines, said sheath, chafe guard, jacket, wire braid, and/or protective coating protecting said at least one line from damage caused by said automatic sliding mechanism.

21. The system of claim 18 wherein at least one of said at least two lines further comprises a metal cable, reinforced rope, and/or fiber core wire rope.

22. The system of claim 18 wherein said wind capturing structure further comprises a sparless kite, a single skin kite, a parawing kite, a sail wing kite, a Rogallo kite, a low line angle kite, a high angle of attack kite, a low lift/drag ratio kite, or any other kite capable of sustained flight.

23. The system of claim 18 wherein said automatic sliding mechanism further comprises associated circuitry, said circuitry capable of controlling said automatic sliding mechanism.

24. A wind-based power generation system comprising a bridle system for optimizing power production, the wind-based power generation system comprising:
a wind capturing structure operating in association with a ground-based power production system for converting wind force to electrical power;
a bridle system for controlling lift and drag forces associated with said wind capturing structure for optimizing production of said electrical power, said bridle system comprising:
at least two lines associated with said wind capturing structure, said at least two lines comprising at least one bridle line and at least one base line coupling said wind capturing structure to said ground-based power production system; and
an unpowered sliding mechanism associated with at least one of said at least two lines, said unpowered sliding mechanism capable of adjusting line tension of said at least one bridle line based on wind conditions, line tension, line length, safety conditions, and/or power conditions.

25. The system of claim 24 wherein said unpowered sliding mechanism further comprises a torsion spring, hydraulic piston, pneumatic piston, and/or another energy storage device.

26. The system of claim 24 wherein said unpowered sliding mechanism further comprises a sheath, chafe guard, jacket, wire braid, and/or protective coating around at least one of said at least two lines, said sheath, chafe guard, jacket, wire braid, or other coating protecting said at least one line from damage caused by said sliding mechanism.

27. The system of claim 24 wherein at least one of said at least two lines further comprises a metal cable, reinforced rope, and/or fiber core wire rope.

28. The system of claim 24 wherein said wind capturing structure further comprises a sparless kite, a single skin kite, a parawing kite, a sail wing kite, a Rogallo kite, a low line angle kite, a high angle of attack kite, or a low lift/drag ratio kite.
